(19) United States
(12) Patent Application Publication
(10) Pub. No.: US 2012/0321766 A1
(43) Pub. Date: Dec. 20, 2012

(54) ANTIOXIDANT CONTAINING LIQUID CREAMERS

(75) Inventors: James Tuot, Dublin, OH (US); Winnie Octavia, Delaware, OH (US); Alexander A. Sher, Dublin, OH (US)

(73) Assignee: NESTEC S.A., Vevey (CH)

(21) Appl. No.: 13/502,927

(22) PCT Filed: Oct. 15, 2010
(86) PCT No.: PCT/EP10/65539

§ 371 Date: Apr. 19, 2012

(30) Foreign Application Priority Data
Oct. 20, 2009 (US) PCT/US2009/061316

(51) Int. Cl. A23C 11/00; A23D 7/005; A23L 1/19; A23L 2/52

(52) U.S. Cl. 426/271; 426/262; 426/542; 426/540

(57) ABSTRACT

Liquid creamer compositions having improved resistance to oxidation, which include an emulsifying component including at least two different low molecular weight emulsifiers in relative amounts sufficient to provide a stabilized emulsion; a cellulose component including a blend of two different cellulose compounds in an amount sufficient to maintain homogeneity of the composition; a carrageenan gum component present in an amount sufficient to maintain homogeneity of the composition; a vegetable oil and optionally a whitening agent in an amount sufficient to provide whitening to an aqueous media to which the creamer is added; water in an amount sufficient to make a liquid creamer and an antioxidant system comprising gum arabic and a carotenoid component in an amount sufficient to provide the liquid creamer with improved resistance to light and temperature induced oxidation.

### FIELD OF INVENTION

The present invention relates to compositions for extended shelf life (ESL) and shelf-stable liquid creamers with improved resistance to oxidation, and to the processes for making them.

### BACKGROUND OF THE INVENTION

Creamers, also known as whiteners, are widely used with hot and cold beverages such as coffee, cocoa, and tea. Creamers can also be used as replacement for milk or dairy cream with powders or particulates such cereals. Creamers are available in both liquid and powder forms. However, creamers in powder forms do not provide an impression of traditional dairy creamers. Moreover, powder creamers may be difficult to dissolve when added to beverages such as coffee, which may result in non homogeneous beverages.

Liquid creamers are essentially oil in water emulsions with the oil phase made of typical food grade oil, sometimes partially hydrogenated. Liquid creamers may undergo oxidation when exposed to light or high temperature or both, with light induced oxidation being a much more serious issue than oxidation induced by high temperature.

Most of the liquid creamers currently on the market are sold chilled as ESL (Extended Shelf Life) creamers and require to be kept in a refrigerator. Even under chilled condition, it has been shown that typical liquid creamers oxidize within a few weeks under a standard 1075 Lux fluorescent light typically found in supermarkets if not protected against this light effect. Typical labels of liquid creamers do not provide adequate light protection that makes this problem worse. For example, a standard label used for liquid creamers in the US cuts light transmission by about 65% in the most important wavelength range of 400 nm to 600 nm, which falls far short from eliminating oxidation. Although better labels exist, they are not favored by marketing because of their undesirable finishes. Thus, the liquid creamers currently on the market inevitably develop some off taste and poor quality due to oxidation when kept too long under light at any temperature.

The desirable shelf stable liquid creamers will be exposed to light at a much higher temperature than the chilled products, and this is expected to increase oxidation as a matter of simple chemistry. The shelf stable liquid creamers undergo oxidation due to two different but somewhat related mechanisms: oxidation induced by temperature alone, and oxidation induced by light and accelerated by temperature.

Oxidation related to temperature alone is a relatively slow phenomenon which, in itself, does not cause a quality degradation serious enough to significantly shorten the shelf life of the shelf stable liquid creamers. For example, shelf stable liquid creamers kept under ambient temperature but in the dark could be still acceptable in sensory qualities after a period of about 6 months, which defines the shelf life of the product. In contrast, oxidation induced by light and accelerated by temperature results in rapid degradation of the quality of shelf stable liquid creamers, rendering them unacceptable to consumers.

Although preventing bulk oil oxidation is known in the art, reducing the light induced oxidation in liquid creamers is a formidable task. Currently, there is no reliable data available regarding the wavelengths most susceptible to carry the damaging energy to start the light induced oxidation process.

It has been shown that emulsion oil oxidation involves different degradation reaction mechanisms from bulk oil oxidation, due to factors such as antioxidants used, chelating agents present, ingredients purity, ingredients partitioning, interfacial characteristics, droplet characteristics, and ingredients interactions. US patent application publication No. 20050184275A1 teaches an antioxidant composition for enhancing the inhibition of oxidation within highly polyunsaturated lipids in oil-in-water and water-in-oil emulsions comprising effective quantities of tocopherols, beta-carotene, egg yolk or soybean phospholipids, and sucrose or sorbitol. European patent No EP 1006809 reveals that oil-in-water dispersions of beta carotene and other carotenoids are stable against oxidation while water-dispersible beadlets of beta carotene are very sensitive to oxidation in diluted juice beverages. U.S. Pat. No. 5,284,674 discloses a powdered dairy creamer optionally comprising vitamin E based antioxidants such as vitamin E dl alpha tocopherol.

Casein, which often used as an emulsifier in liquid creamers, is known to help reduce light induced oxidation. However, it has been demonstrated that even liquid creamers with high level of casein undergo a significant degradation when exposed to light. For example, liquid creamers containing casein were found degraded after 3 to 6 weeks under 1075 Lux fluorescent light even when kept at 4° C. in a package that allows 50% light transmission across all visible spectrum. Protein-free liquid creamers, which contain no casein, are even more rapidly degraded under light.

Although quite a few antioxidants are known, experts in the field have cautioned that most known antioxidants can also undesirably act as a pro-oxidant, depending on the specific composition of food matrix.

Therefore, there is a need in the industry for liquid creamers with improved resistance to light induced oxidation as well as temperature related oxidation. In particular, there is a need to find a satisfactory antioxidant(s) capable of protecting liquid creamers, especially with low protein and protein-free, from light and temperature induced oxidation.

### SUMMARY OF THE INVENTION

The invention set forth herein satisfies the unmet needs of the art by providing a liquid creamer composition having improved resistance to light and temperature induced oxidation, which comprises an emulsifying component including at least two different low molecular weight emulsifiers in relative amounts sufficient to provide a stabilized emulsion; a cellulose component including a blend of two different cellulose compounds in an amount sufficient to maintain homogeneity of the composition; a carrageenan(s) gum component present in an amount sufficient to maintain homogeneity of the composition; a buffer system in sufficient amount to maintain desired pH; vegetable and water in an amount sufficient to make a liquid creamer; and an antioxidant system comprising gum arabic and a carotenoid(s) component in an amount sufficient to provide liquid creamer with improved resistance to light and/or temperature induced oxidation. The liquid creamers may also contain one or more of protein(s), chelating agent(s), flavor(s), sweetener(s), and colorant(s), and a whitening agent in an amount sufficient to provide additional whitening to an aqueous media to which the creamer is added.

The invention further provides for a beverage comprising an aqueous liquid, a beverage-forming component such as coffee, tea, chocolate or a fruit drink, and the creamer of the invention in an amount sufficient to provide a creaming effect to the beverage. The creamer of the invention can also be used as a dairy replacement for consumption with food such as cereals and berries, or for use in cooking as creamers for soups and other applications.

The invention also provides for a process of manufacture of the liquid creamer of the invention comprising providing the emulsifying components, cellulose components, carageenan gum components, antioxidant component(s), or a combination thereof; and dissolving the components in water with agitation. The water may be cold, hot, or cold and then heated, or hot and then cooled. In one embodiment, this process may further comprise adding one or more of sweetener(s), protein(s), chelating agent(s), flavor(s), colorant(s) and the whitening agent in powder or liquid form, or a combination thereof, into the water with agitation. Additionally, vegetable oil is added to the water or to the wet-mix to produce a mixture of all components, followed by subjecting the mixture to a heat treatment selected from the group consisting of ultra-high temperature (UHT) pasteurization or sterilization, retorting and other thermoprocessing procedures. Subsequent process steps include homogenization, cooling, and then filling in containers under aseptic conditions to produce the liquid creamer.

Yet another embodiment of the invention relates to the use of an antioxidant system comprising gum arabic and a carotenoid component to provide a liquid creamer with improved resistance to light and temperature induced oxidation.

### DETAILED DESCRIPTION OF THE PREFERRED EMBODIMENTS

As noted, liquid creamers, and in particular those that are shelf stable such that they can be stored at room temperature rather than under refrigerated conditions, experience light and temperature oxidation, and it is the goal of this invention to offset or counteract this problem. While it seems to be logical to add antioxidants for this purpose, this is not a simple task as some can affect the taste, color or organoleptic properties of the creamer, while many others undesirably act as a pro-oxidant or to deleteriously affect certain physical properties of the creamers (e.g., viscosity). Thus, suitable antioxidants cannot be easily discovered without much more than routine testing.

Chlorophyll could be a possible cause for light induced oxidation, but use of oil without any chlorophyll residual like partially hydrogenated cottonseed oil confirmed that the oxidation was not to any measurable extent related to the possible chlorophyll content.

To attempt to provide liquid creamers with the right antioxidant(s), different antioxidants and their combinations were tested. Known antioxidant(s) or combinations thereof, or combination of antioxidant(s) and chelating agent(s) such as tocopherols alone, tocopherols and ethylenediaminetetraacetic acid (EDTA), tocopherols and tert-butylhydroquinone (TBHQ), citric acid and TBHQ, TBHQ alone, a blend of Vitamin E and Vitamin C, were all found to be incapable of reducing the light induced oxidation to any significant degree.

After further testing, it was surprisingly found that antioxidant systems comprising gum arabic and carotenoid(s) are effective in reducing light induced oxidation as well as minimizing temperature related oxidation, and suitable for using with a commercially acceptable liquid creamer in terms of color and sensory properties. Thus, the invention relates to the use of these antioxidant systems to impart the necessary oxidation resistance to such liquid creamers without deleteriously affecting the organoleptic properties of those creamers, as well as to the resulting creamer compositions that contain these antioxidant systems.

The gum arabic component of these antioxidant systems is a hydrocolloid widely used in beverages as foam stabilizer and emulsifier to enhance mouth-feel. Gum arabic reduces surface tension of liquids, which leads to increased fizzing in carbonated beverages, in addition to encapsulating and stabilizing flavors and colors. Gum arabic differs from other hydrocolloids, which are polysaccharides, in that gum arabic also contains a protein fraction, namely a highly branched arabinogalactan-protein complexes. Specifically, gum arabic has an amphiphilic protein fraction and a branched polysaccharide fraction linked to the protein fraction. It is likely that the amphiphilic protein fraction of the gum arabic cooperates with fat droplets in the liquid creamer while the branched polysaccharide fraction of the gum arabic may provide a steric hindrance around the fat droplets to reduce or slow down the access of oxidants or pro-oxidants, e.g. metallic cations to the fat droplets. As such, oxidation is reduced while the stability and shelf life of the liquid creamer are increased. This is highly useful for liquid creamers.

The gum arabic most effective in preventing oxidation is high in arabinogalactan-protein, the concentration of which must be standardized in the gum arabic to have repeatable results. Examples of commercially available gum arabic includes TIC PRETESTED® TICAMULSION® A-2010 Powder, TIC PRETESTED® PRE-HYDRATED° GUM ARABIC SPRAY DRY FCC powder and TIC PRETESTED® GUM ARABIC FT PRE-HYDRATED® powder. Advantageously, only a small amount of gum arabic in combination with a carotenoid component is necessary to protect against light and temperature induced oxidation in liquid creamers. This could be due to a synergetic effect between the carotenoid and the gum.

In one preferred embodiment, the liquid creamer composition of the invention comprises gum arabic in an amount of about 0.1% to about 1.5% weight percentage of the final composition which typically contains about 8% oil. Since gum arabic is neutral in taste, it does not impart any off flavor to the liquid creamer, nor does it affect the viscosity of the liquid creamer at these low concentrations.

In another preferred embodiment, the liquid creamer composition of the invention comprises both gum arabic and a carotenoid component such as beta carotene or a blend of natural carotenoids. In these compositions, the gum arabic may be present at the oil/water interface but outside of the emulsifier layer while the carotenoid component is dissolved into the oil phase.

The liquid creamer of the invention may also contain an antioxidant system comprising a system of gum arabic and carotenoid alone, or in combination with another antioxidant. In one embodiment of the invention, the liquid creamer composition includes a gum arabic-antioxidant system comprising beta carotene in an amount of 0.5-30 ppm 5-30 ppm and alpha tocopherols in an amount of 20-110 ppm. Such systems have been found to completely suppress all light induced oxidation. However, at the high level of beta carotene, the creamer color could be unacceptable for some consumers. The use of tocopherols to assist in providing oxidation resistance is completely unexpected given that the use of tocopherols alone was found to be ineffective for this purpose.

In another embodiment of the invention, the liquid creamer composition contains a gum arabic-antioxidant system comprising beta carotene in an amount of about 0.5-30 ppm 5 ppm, and food grade EDTA as a chelating agent in an amount of about 1-2 ppm, which also suppresses oxidation.

Surprisingly, liquid creamers comprising even lower concentrations of beta carotene, i.e., 0.5 ppm and 3.0 ppm, with or without EDTA are also significantly less prone to light induced oxidation. Due to the reduced amount of beta carotene, these liquid creamers only have a light yellow color and a desirable taste profile not affected by the presence of this small amount of beta carotene, as confirmed by sensory analysis after prolonged period of constant exposure to 1075 Lux fluorescent light at 30° C.

A chelating agent such as EDTA is added to protect against the pro-oxidation effects of transition metals such as iron and copper, and might not be needed depending on the quality and source of raw ingredients of the liquid creamers. Although no transition metal is present in the recipe, liquid creamers processed in the US have been found to contain an unexpectedly high level of transition metals, which makes it necessary to add chelating agent(s) including, but not limited to, EDTA, sodium or potassium salts of EDTA, citric acid, amino acids, sodium or potassium salts of amino acids, sodium or potassium hexamethaphosphates, sodium or potassium tri-, tetra- and other polyphosphates, sodium or potassium citrate, sodium or potassium tartrate, or combinations thereof.

In one embodiment, the liquid creamer of the invention includes an antioxidant system comprising a blend of gum arabic, beta carotene in an amount of about 5 ppm, EDTA in an amount of about 2 ppm, which inhibits light induced oxidation in the liquid creamer for up to 3 months at 30° C. under 1075 Lux fluorescence light.

In addition to the antioxidant system described above, the liquid creamer composition of the invention further comprises: (i) an emulsifying component including at least two different low molecular weight emulsifiers in relative amounts sufficient to provide a stabilized emulsion; (ii) a cellulose component including a blend of two different cellulose compounds in an amount sufficient to maintain homogeneity of the composition; (iii) a carageenan gum component present in an amount sufficient to maintain homogeneity of the composition; (iv) a buffer system in sufficient amount to maintain desired pH; and (v) vegetable oil and water in an amount sufficient to make a liquid creamer. The liquid creamers may also contain protein(s), chelating agent(s), flavor(s), sweetener(s), colorant(s) and a whitening agent in an amount sufficient to provide additional whitening to an aqueous media to which the creamer is added

In a further embodiment, the liquid creamer is a low-protein liquid creamer or a protein-free liquid creamer.

To achieve a superior emulsion stability, the emulsifier component of the liquid creamer composition comprises a combination of at least one low HLB emulsifier and at least one medium HLB emulsifier in a weight ratio of about 5:1 to about 1:20, preferably from about 3:1 to about 1:7, and most preferably from about 1.5:1 to about 2:4 with the low and medium HLB emulsifiers together being present in an amount of about 0.05 to 0.8% by weight of the total composition.

The hydrophilicity and lipophilicity are different among emulsifiers, and the balance between the two is called HLB value. The HLB value is determined by calculating hydrophilic or lipophilic values of the different regions of the molecule. Various references relate to the HLB value. Examples are Griffin W C: “Classification of Surface-Active Agents by ‘HLB,’” Journal of the Society of Cosmetic Chemists 1 (1949): 311, or Griffin W C: “Calculation of HLB Values of Non-Ionic Surfactants,” Journal of the Society of Cosmetic Chemists 5 (1954): 259.

The HLB value of an emulsifier typically ranges from 0 to 20. Usually, a low HLB emulsifier has an HLB value between 1 and 4, while a medium HLB emulsifier has an HLB value between 5 and 10.

The emulsifiers used are not limited to those of a single acyl or fatty acid component, such as on a specific carbon chain length or degree of unsaturation. In preferred embodiments, the emulsifiers are monoglycerides and acid esters of monoglycerides. Particularly preferred embodiments include a combination of monoglycerides and acid esters of monoglycerides. In some embodiments, low molecular weight emulsifiers with low HLB values are selected from the group consisting of monoglycerides, diglycerides, acetylated monoglycerides, sorbitan trioleate, glycerol dioleate, sorbitan tristearate, propyleneglycol monostearate, glycerol monooleate and monostearate, alone or in combination, while the low molecular weight emulsifiers with medium HLB values are selected from the group consisting of sorbitan monooleate, propylene glycol monolaurate, sorbitan monostearate, calcium stearoxyl-2-lactylate, glycerol sorbitan monopalmitate, soy lecithin, and diacetylated tartaric acid esters of monoglycerides, alone or in combination.

In one preferred embodiment, the liquid creamer composition includes a cellulose component as a blend of microcrystalline cellulose (MCC) and carboxymethylcellulose (CMC), and a carageenan gum component. The cellulose and gum components are present in an amount that is sufficient to maintain the composition in a homogenous state, such that there is no phase separation, sedimentation, creaming, feathering, gelation, or changes in viscosity. Thus, the cellulose and gum components contribute to a hydrocolloid stabilizing system that helps to maintain stability of the creamer composition alone, and also when added to a liquid media.

In accordance with a preferred invention embodiment, the MCC/CMC/carrageenan stabilizing system is present in an amount from about 0.05 to 1%, more preferably from 0.2 to 0.7%, and most preferably from 0.3 to 0.5% by weight of the total composition, with the cellulose and carrageenan gum components present in a weight ratio of between 200:1 and 1:10. Use of less than 0.05% of total hydrocolloids resulted in creaming, phase separation and in an off-flavor in the liquid creamer samples, while levels of total hydrocolloids higher than 1% resulted in severe syneresis and gelation of the samples. Syneresis is the contraction of a hydrated system, usually hydrocolloids resulting in the exudation of part of its liquid component, i.e. watering layer on the top or bottom of the liquid product. Gelation is the process of forming a gel. Gels are defined as a substantially dilute crosslinked system, which exhibits no flow when in the steady-state. By weight, gels are mostly liquid, yet they behave like solids due to a three-dimensional crosslinked network within the liquid. It is the crosslinks within the fluid that give a gel its structure (hardness) and contribute to stickiness. Phase separation that can be observed in liquid creamers are creaming, syneresis, marbling and other layering and/or gelation. These undesirable effects could be easily observed visually, e.g. different color layers for phase separation or in significantly increased viscosity for gelation during the storage, especially at high temperature.

The cellulose component of the liquid creamer composition can be present in an amount of about 0.01 to 1%, preferably about 0.2 to 0.6%, and most preferably about 0.3 to 0.5% by weight of the composition. The ratio of MCC to CMC is preferably about 8:1 to 12:1, and most preferably about 9:1 to 10:1.

The carrageenan gum component is preferably present in an amount of about 0.005 to 0.1 percent by weight of the composition, and can be a kappa carrageenan, an iota, and optionally lambda carrageenan, or a combination thereof. In accordance with one embodiment of the invention, the carrageenan is a kappa/iota carageenan blend, in weight to weight ratio of about 6:1 to about 1:10. Lamda carrageenan can be added optinally to maintain desired product viscosity.

In some embodiments, the liquid creamer of the invention further comprises additional antioxidants selected from the group consisting of tocopherols, sulphite, vitamin A and precursors thereof.

The liquid creamer of the invention may also include one or more pH buffer to achieve a pH range preferably about 6 to 8 and more preferably about 6.5 to 7.5. Non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be present in an amount of about 0.05 to about 2.1% of the total weight of the composition.

Optionally, the liquid creamer composition can contain sweeteners, including but not limited to sucrose, fructose, maltodextrin, high fructose corn syrup, other natural sweeteners, artificial sweeteners, or combination of thereof. The sweeteners may be present in concentration from about 0.1 to 50%, and preferably from about 5 to 30% by weight of the total composition.

The liquid creamers can also include added colors and/or flavors. Optionally, the whitening agent of the liquid creamer composition is titanium dioxide, which can be present in an amount of about 0.1 to about 1% by weight of the composition. The titanium dioxide can have a particle size ranging 0.1 to 0.7 microns, with a preferred embodiment having a particle size of about 0.4 microns.

The liquid creamer composition also contains from about 0.1 to 33 wt % of vegetable oil(s). The vegetable oil(s) can include partially or wholly hydrogenated oils, alone or in combination. Suitable vegetable oils include, but are not limited to, soybean oil, coconut oil, palm oil, cotton seed oil, canola oil, olive oil, sunflower oil, and safflower oil.

The liquid creamer composition may further comprise at least one food grade preservative selected from the group consisting of sodium benzoate, potassium benzoate, sorbic acid, sodium sorbate, potassium sorbate, sulfites, and combinations thereof.

Embodiments of the invention also include a beverage comprising an aqueous liquid, a beverage-forming component, and a liquid creamer composition of the invention in an amount sufficient to provide a creaming effect to the beverage. The beverage forming component can be coffee, tea, chocolate, or a fruit drink. The beverage forming component can also be a powder or crystal substance, typically having some sort of flavor, such as cocoa, malt, or fruit flavor crystals. The invention also could be extended to the use of a creamer as a dairy replacement that can be consumed directly or with other food such as cereal or for use in cooking.

The present invention further provides a process of making the liquid creamer of the invention, which includes providing the emulsifying components, cellulose components, carrageenan gum components, antioxidant component(s), in powder or liquid form, or a combination thereof; buffer(s) in powder or liquid form, or a combination thereof, and dissolving the components in water under agitation. The optional components such as chelating agent(s), flavor(s), colorant(s) including the whitening agent as titanium dioxide, and sweetener(s), in liquid or powder form, can also be included in this step. Next, a vegetable oil is added to the hot water to produce a mixture of all components. The mixture then undergoes UHT heat treatment, homogenization, cooling, and filling in containers under aseptic conditions. Homogenization can be performed before and/or after the heat treatment.

The advantages of the invention are numerous. In particular, it has been found and confirmed that light induced oxidation is a main culprit for shelf stable liquid creamer degradation over storage, whereas temperature related degradation is more limited. Built upon this discovery, antioxidant systems comprising gum arabic and carotenoid(s) are used to mitigate and significantly reduce light and/or temperature induced oxidation in liquid creamers to deliver shelf stable liquid creamers of high qualities. The antioxidant system may also comprise chelating agent(s), and/or tocopherol(s).

### EXAMPLES

The invention is further defined by reference to the following illustrative, non-limiting examples.

### Example 1

10 g of kappa-carrageenan, 20 g of iota-carrageenan, 500 g of sucrose, and 250 g of gum arabic was mixed together with 100 g of 10:1 MCC/CMC blend. The dry blend was added into 80 kg of about 75° C. hot water (65-85° C.) under high agitation. Further, 200 g of disodium phosphate and 200 g of dipotassium phosphate were added to the tank under continuous agitation.

300 g of titanium dioxide, 50 g of sodium caseinate, and 20 g of flavor were blended together. The dry blend was added to the tank of hot water with above stabilizers under agitation. After about 10 minutes of mixing, 100 g of Dimodan® and 280 g of Panodan® were added under continuous agitation. 5 kg of oil was added under high agitation, followed by 0.5 g (5 ppm) of beta carotene and then by 4.5 kg of sucrose. Finally, under continuous agitation, additional water was added to have total weight of 100 kg. The liquid was then UHT treated for 5 sec at 143° C., homogenized at 180/40 bar, cooled and the coffee whitener was aseptically filled into jars, jugs or pouches.

The product was stored for 3 months at 30° C. under 1075 Lux fluorescent light. Light and temperature induced oxidation in the liquid creamer was significantly reduced as compared to the control without added gum arabic and without added beta-carotene. No change in creamer physical stability was found during the storage. Further, the addition of the creamer to hot coffee did not cause emulsion destabilization, feathering, flocculation, de-oiling, or sedimentation in the whitened coffee.

### Example 2

A coffee creamer was prepared as in Example 1 but using 0.1 ppm of beta-carotene.

The product was stored during 3 months at 30° C. under 1075 Lux fluorescent light. No changes in physical stability of the creamer during the storage were found, however practically no improvement in preventing product oxidation was found as compared to the control without gum arabic and beta-carotene.

### Example 3

A coffee creamer was prepared as in Example 1 but using 35 ppm of beta-carotene.

The product was found organoleptically unacceptable due to significant change of creamer color.

### Example 4

A coffee creamer was prepared as in Example 1 but using 1.6% gum arabic.

The creamer was found unacceptable due to significant increase in product viscosity.

### Example 5

A coffee creamer was prepared as in Example 1 but using 0.05% gum arabic.

The product was stored during 3 months at 30° C. under 1075 Lux fluorescent light. No changes in physical stability of the creamer during the storage were found, however practically no improvement in creamer oxidation stability was found as compared to the control without gum arabic and beta-carotene.

### Example 6

A coffee creamer was prepared as in Example 1 but with addition 2 ppm EDTA and 20 ppm of tocopherols

The product was stored during 3 months at 30° C. under 1075 Lux fluorescent light. The creamer was found physically stable after the storage, and temperature and light induced oxidation was completely inhibited, resulting in good creamer organoleptic quality.

The embodiments and examples illustrated and discussed in this specification are intended only to teach those skilled in the art the best way known to the inventors to make and use the invention. The above-described embodiments of the invention may be modified or varied, without departing from the invention, as easily appreciated by those skilled in the art in light of the above teachings. Accordingly, all expedient modifications readily attainable by one of ordinary skill in the art from the disclosure set forth herein, or by routine experimentation therefrom, are deemed to be within the spirit and scope of the invention as defined by the appended claims.

1. A liquid creamer composition comprising:
an emulsifying component including a combination of at least one low HLB emulsifier and at least one medium HLB emulsifier, the low HLB emulsifier:medium HLB emulsifier weight ratio being about 5:1 to about 1:20, the low and medium HLB emulsifiers together being present in an amount of about 0.05 to 0.8% by weight of the total composition;
a cellulose component including a blend of microcrystalline cellulose (MCC) and carboxymethylcellulose (CMC) comprising in a total amount about 0.01 to about 1 percent by weight of the composition, with the MCC and CMC having a weight ratio of about 8:1 to 12:1;
a carrageenan gum component comprising an amount of about 0.005 to about 0.1 percent by weight of the composition;
a buffer system in an amount sufficient to maintain the pH at between 6 and 8;
oil and water in an amount sufficient to make a liquid creamer; and
an antioxidant system comprising gum arabic in the amount comprising 0.1% to 1.5% by weight of the total composition and a carotenoid component comprising about 0.5 ppm to 30 ppm.

2. The composition according to claim 1, wherein the carotenoid component comprises beta carotene.

3. The composition according to claim 1, comprising one or more additional antioxidants selected from the group consisting of a tocopherol, sulphite, vitamin A and precursors thereof.

4. The composition according to claim 1, wherein the low HLB emulsifier is selected from the group consisting of a monoglyceride, diglyceride, acetylated monoglyceride, sorbitan trioleate, glycerol dioleate, sorbitan tristearate, propyleneglycol monostearate glycerol, monooleate and monostearate, and combinations thereof, and wherein the medium HLB emulsifier is sorbitan selected from the group consisting of monooleate, propylene glycol monolaurate, sorbitan monostearate, calcium stearoxyl-2-lactylate, glycerol sorbitan monopalmitate, soy lecithin, diacetylated tartaric acid esters of monoglycerides, and combinations thereof.

5. The composition according to claim 1, wherein the carrageenan gum component is selected from the group consisting of a kappa carrageenan gum, an iota carageenan gum, and optionally lambda carrageenan and combinations thereof.

6. The composition according to claim 1, wherein the carrageenan gum component is a combination of a kappa carrageenan and an iota carrageenan in a weight ratio of about 6:1 to about 1:10.

7. The composition according to claim 1 comprising a whitening agent, wherein the whitening agent is titanium dioxide having a particle size of about 0.1 to about 0.7 microns and comprising about 0.1 to about 1 percent by weight of the composition.

8. The composition according to claim 1 comprising a chelating agent selected from the group consisting of EDTA, sodium or potassium salts of EDTA, citric acid, amino acids, sodium or potassium salts of amino acids, sodium or potassium hexamethaphosphates, sodium or potassium tri-, tetra- and other polyphosphates, sodium or potassium citrate, sodium or potassium tartrate, and combinations thereof.

9. The composition according to claim 1 comprising a pH buffer in an amount of 0.05 to 2.1% by weight of the composition.

10. The composition according to claim 1 comprising a sweetener comprising about 0.1 to about 50 percent by weight of the composition.

11. The composition according to claim 1 comprising a vegetable oil in an amount of about 0.1 to about 33 percent by weight of the composition.

12. The composition according to claim 1 comprising one or more ingredients selected from the group consisting of chelating agent, flavor, sweetener, and colorant.

13. A beverage comprising an aqueous liquid, a beverage-forming component, and a liquid creamer composition comprising an emulsifying component including a combination of at least one low HLB emulsifier and at least one medium HLB emulsifier, the low HLB emulsifier:medium HLB emulsifier weight ratio being about 5:1 to about 1:20, a cellulose component including a blend of microcrystalline cellulose (MCC) and carboxymethylcellulose (CMC), with the MCC and CMC having a weight ratio of about 8:1 to 12:1, a carrageenan gum component; a buffer system; oil and water; and an antioxidant system comprising gum arabic and a carotenoid component in an amount sufficient to provide a creaming effect to the beverage.

14. The beverage of claim 13 wherein the beverage-forming component is selected from the group consisting of coffee, tea, chocolate and a fruit drink.

15. A method of manufacturing a liquid creamer composition which comprises providing emulsifying components, cellulose components, carrageenan gum components, component, buffer, in powder or liquid form; and dispersing the components in water under agitation to produce a liquid creamer composition comprising:
an emulsifying component including a combination of at least one low HLB emulsifier and at least one medium HLB emulsifier, the low HLB emulsifier:medium HLB emulsifier weight ratio being about 5:1 to about 1:20, the low and medium HLB emulsifiers together being present in an amount of about 0.05 to 0.8% by weight of the total composition;
a cellulose component including a blend of microcrystalline cellulose (MCC) and carboxymethylcellulose (CMC) comprising in a total amount about 0.01 to about 1 percent by weight of the composition, with the MCC and CMC having a weight ratio of about 8:1 to 12:1;
a carrageenan gum component comprising an amount of about 0.005 to about 0.1 percent by weight of the composition;
a buffer system in an amount sufficient to maintain the pH at between 6 and 8;
oil and water in an amount sufficient to make a liquid creamer; and
an antioxidant system comprising gum arabic in the amount comprising 0.1% to 1.5% by weight of the total composition and a carotenoid component comprising about 0.5 ppm to 30 ppm.

16. The method according to claim 15, which further comprises one or more ingredients selected from the group consisting of chelating agent, flavor, sweetener, and colorant including the whitening agent.

17. The method according to claim 15 comprises adding a vegetable oil to the water to produce a mixture of all components, followed by subjecting the mixture to a heat treatment, homogenization, cooling, and filling in containers under aseptic conditions.

18. A method of use of providing a liquid creamer with improved resistance to light and temperature induced oxidation comprising the steps of producing the creamer using an antioxidant system containing gum Arabic and a carotenoid component.
